(19) United States
(12) Patent Application Publication
(10) Pub. No.: US 2025/0313495 A1
(43) Pub. Date: Oct. 9, 2025

(54) Vortex Structuring of Water

(71) Applicant: UpTerra Corporation, San Rafael, CA (US)

(72) Inventor: Ahmad Reza Givsan, San Rafael, CA (US)

(21) Appl. No.: 18/860,517

(22) PCT Filed: Apr. 27, 2023
(86) PCT No.: PCT/US23/20283

§ 371 Date: Oct. 25, 2024

Related U.S. Application Data
(60) Provisional application No. 63/335,566, filed on Apr. 27, 2022.
(60) Provisional application No. 63/335,544, filed on Apr. 27, 2022.
(60) Provisional application No. 63/419,296, filed on Oct. 25, 2022.

(51) Int. Cl. C02F 1/34; C02F 1/48

(52) U.S. Cl. CPC C02F 1/34; C02F 1/48

(57) ABSTRACT

A funnel for treating a fluid is described. The funnel has an inlet, an outlet, and a side wall that has a substantially phi curvature. The inlet is oriented substantially perpendicular to the phi curvature such that a vortex pathway between the inlet and outlet is achieved. As fluid flows through the vortex pathway, individual molecules in the fluid reorient into similar orientations such that the molecules form coherency domains and harmonic resonance. The structured fluid can be fed to an organism for improved health and/or growth.

This application is a national stage filing of PCT/US23/20283, filed on Apr. 27, 2023, which claims priority to U.S. provisional application Ser. No. 63/335,566, filed on Apr. 27, 2023, and also claims priority to PCT application serial number PCT/US2023/020281, filed Apr. 27, 2023, which claims to priority to U.S. provisional application Ser. No. 63/335,544, filed on Apr. 27, 2022, and U.S. provisional application Ser. No. 63/419,296, filed on Oct. 25, 2022.

### FIELD OF THE INVENTION

The field of the invention is water treatment, in particular, funnels for creating vortexes.

### BACKGROUND

The background description includes information that may be useful in understanding the present inventive subject matter. It is not an admission that any of the information provided herein is prior art or relevant to the presently claimed invention, or that any publication specifically or implicitly referenced is prior art. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

It is well known that water molecules will organize into clusters or “coherent domains” when exposed to electromagnetic fields, due to change in molecule oscillations. US2006/0273020 to Bagley, for example, teaches using an oscillating crystal to modify or “structure” water molecule clusters. Bagley also teaches connecting the crystal to a battery to oscillate the crystals at specific frequencies for different purposes. US20140170059 to Czech teaches using electrodes and salt in water to electrically discharge water clusters and improve efficacy against micro-organism. US20210228718 to Camisasca teaches irradiating water with light energies at specific combinations of frequency ranges to medically treat patients suffering from poor sense of balance.

Bagley, Czech, Camisasca, and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

It would be advantageous to provide devices, systems, and methods for structuring fluids that do not require crystals or electromagnetic fields.

Thus, there remains a need for improved devices, systems, and methods for structuring fluids.

### SUMMARY OF THE INVENTION

The inventive subject matter provides methods and devices for treating a fluid, comprising a funnel having an inlet and an outlet, and a side wall between the inlet and the outlet, wherein a least a portion of the side wall has a substantially phi curvature.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a funnel.

FIG. 2 is an illustration of a phi curve.

FIG. 3 is a top perspective cross-sectional view of the funnel of FIG. 1.

FIG. 4 is a top cross-sectional view of the funnel of FIG. 1.

FIG. 5 is an image of prior art unstructured water.

FIG. 6 is an image of structured water.

FIG. 7 is an image of human blood after consumption of unstructured water.

FIG. 8 is an image of human blood after consumption of structured water.

FIG. 9 is an illustration of a fluid progressively flowing through the funnel in FIG. 1.

### DETAILED DESCRIPTION

The following discussion provides many example embodiments of the inventive subject matter. The embodiments described herein are not intended to be an exhaustive list or to limit the inventive subject matter to the precise form disclosed. The disclosed embodiments are chosen and described to merely explain the principles of the inventive subject matter and its application and practical use so as to enable others skilled in the art to follow its teachings.

The inventive devices, systems, and methods will be understood, both as to its structure and operation, from the accompanying drawings, taken in conjunction with the accompanying description. Although each embodiment represents a single combination of inventive elements, the inventive subject matter is considered to include all possible combinations of the disclosed elements. As such, it should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise. Thus, if one embodiment comprises elements A, B, and C, and a second embodiment comprises elements B and D, then the inventive subject matter is also considered to include other remaining combinations of A, B, C, or D, even if not explicitly disclosed.

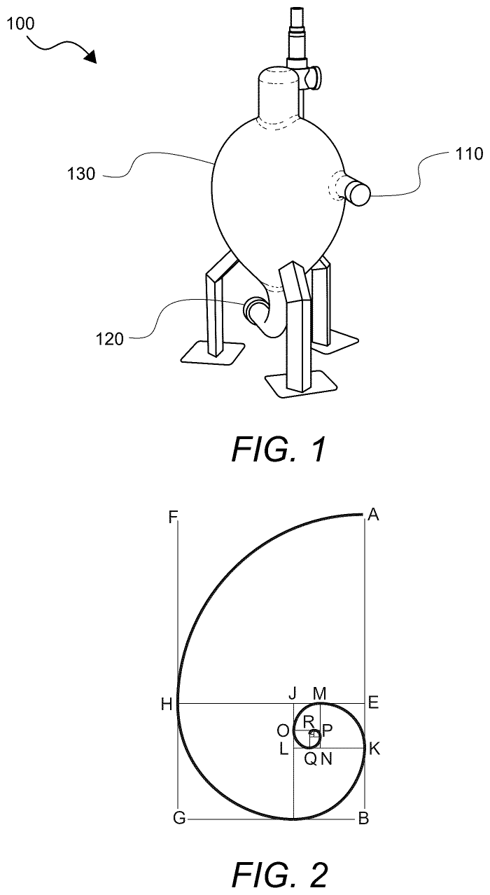

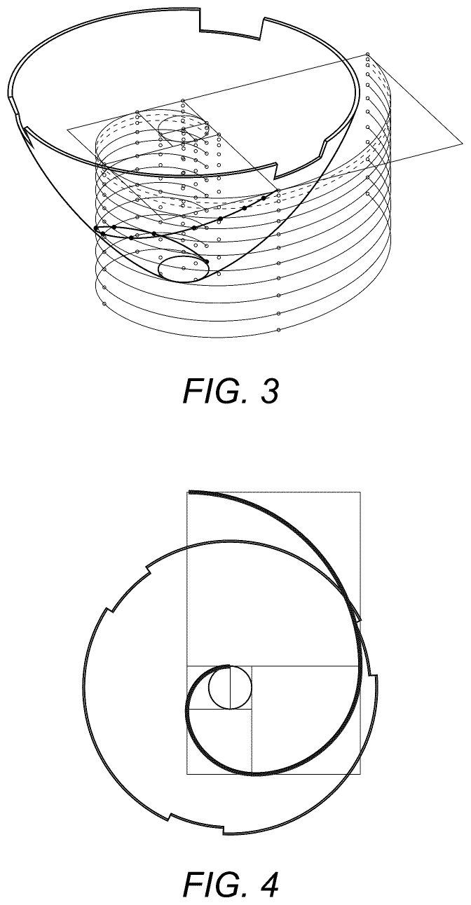

FIG. 1 shows a funnel 100 having an inlet 110, an outlet 120, and a side wall 130 between the inlet and the outlet. A portion of the side wall 130 has a substantially phi curvature. Phi is defined as the golden ratio (1.618), as shown in FIG. 2. FIG. 3 shows a top perspective cross-sectional view of funnel 100. FIG. 4 shows a top cross-sectional view of funnel 100. As used herein, “substantially” phi curvature means approximately 1.618, preferably within 1.4 and 1.8, more preferably within 1.5 and 1.7, and most preferably within 1.58 and 1.65. In some embodiments, the substantially phi curvature is continuous from the inlet to the outlet. As used herein, “continuous” phi curvature means without any interrupting portions that do not have a curvature between 1.4 and 1.8.

Funnel 100 can be made of plastic or any other material suitable for containing the fluid. Funnel 100 has a circular cross-section. However, other cross-sections are contemplated, such as an oblong or elliptical cross-section. Other geometric shapes and irregular cross-sections are also contemplated. Funnel 100 can be connected to a container for collecting the treated fluid.

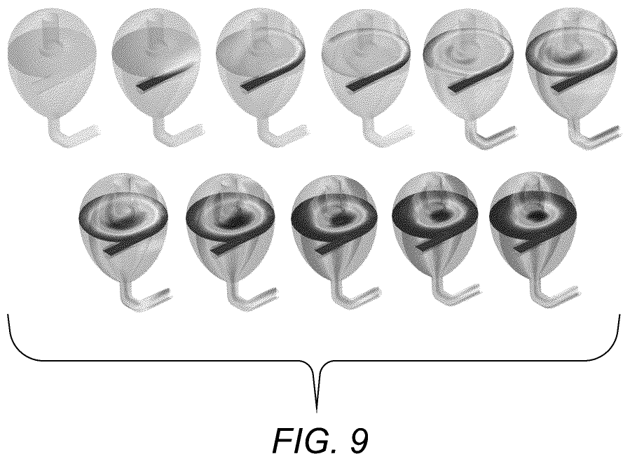

Inlet 110 is oriented substantially perpendicular to the phi curvature of side wall 130 such that the fluid rotates and spirals down the phi curvature of side wall 130. As the fluid flows from inlet 110 to outlet 120, the fluid flows into a vortex pathway. FIG. 9 illustrates the progressive phases of the fluid as it flows from inlet 110 to outlet 120 to create a vortex pathway.

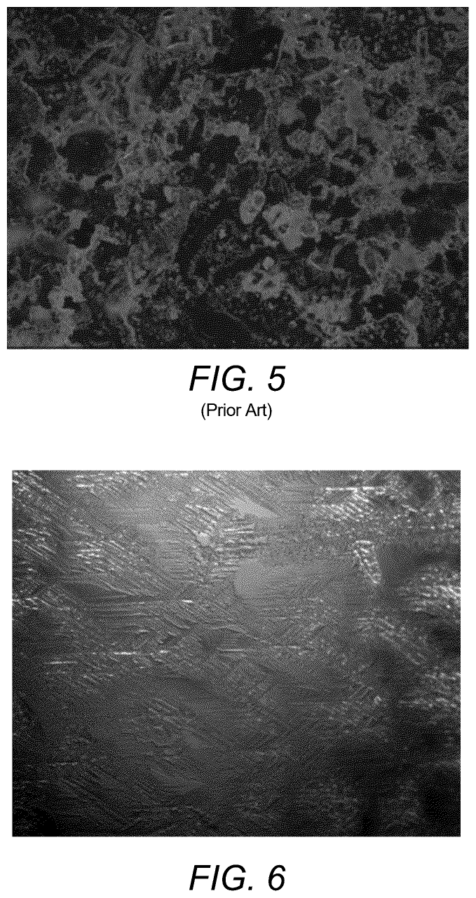

This vortex pathway causes individual molecules in the fluid to reorient into similar orientations such that the molecules form coherency domains (e.g., clusters of coherently bonded molecules) and harmonic resonance. The structured fluid has beneficial properties that can be leveraged for many different applications. In some applications, the fluid can comprise water and the water can be fed to an organism such as an animal or plant to increase health and/or growth. FIG. 5 is an image of prior art unstructured municipal water 9% dilution by volume of Sodium Chloride showing the mineral structure under 40× magnification under dark field microscopy. The image shows the mineral base organization of the unstructured water, which lacks charge distribution and coherence. FIG. 6 is an image of structured water after passing through funnel 100. The structured water is municipal water 9% dilution by volume of Sodium Chloride under 60× magnification under dark field microscopy. The image demonstrates mineral base organization of structured water, which has charge distribution and increased coherence due to the vortex pathway in funnel 100.

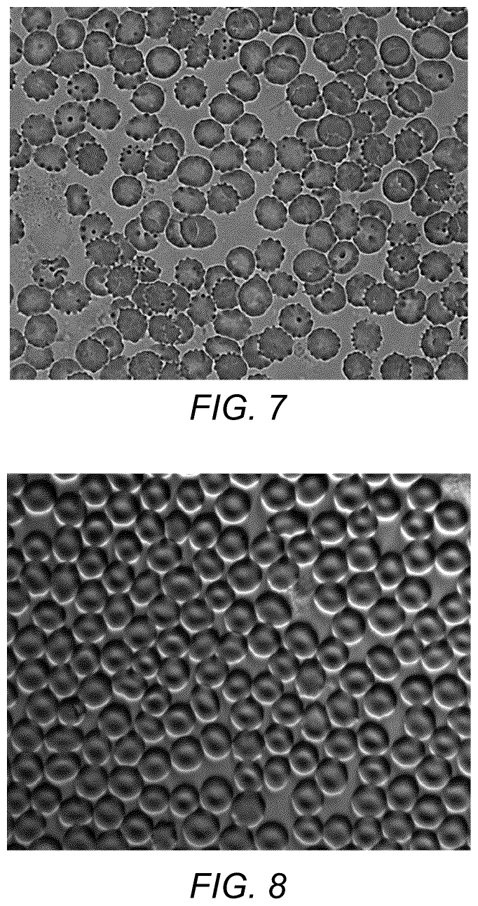

FIGS. 7 and 8 demonstrate the effect of structured water on human blood. FIG. 7 is an image of a human blood sample under 60× magnification under phase 2 light field microscopy, five minutes after ingesting 4 oz of unstructured water. The image shows an acidic blood plasma and RBCs oxygen carrying potential decreased. FIG. 8 is an image of a human blood sample from the same person under 60× magnification under phase 2 light field microscopy, five minutes after ingesting 4 oz of structured water from funnel 100. The image shows a more alkaline of homeostatic blood plasma, increased hydration, and RBC oxygen carrying potential increased. The image demonstrates how structured water can increase biological resonance and information sharing across coherent domains in structured water.

It is further contemplated that the funnel can also be used in combination with crystals and/or electromagnetic radiation to achieve greater efficiency in structuring the fluid, as disclosed in further detail in provisional application No. 63/335,544 filed on Apr. 27, 2022, provisional application No. 63/419,296 filed on Oct. 25, 2022, and PCT/US2023/20281 filed on Apr. 27, 2023, which are incorporated herein by reference.

The recitation of ranges of values herein is merely intended to serve as a shorthand method of referring individually to each separate value falling within the range. Unless the context dictates the contrary, all ranges set forth herein should be interpreted as being inclusive of their endpoints, and open-ended ranges should be interpreted to include only commercially practical values. Similarly, all ranges and all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the claims unless explicitly stated or context dictates otherwise. No language in the specification should be construed as indicating any non-claimed element essential to the practice of the inventive subject matter.

Groupings of alternative elements or embodiments disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A device for treating a fluid, comprising:
a funnel having an inlet and an outlet, and a side wall between the inlet and the outlet,
wherein a least a portion of the side wall has a substantially phi curvature.

2. The device of claim 1, wherein the substantially phi curvature is approximately 1.618.

3. The device of claim 1, wherein the substantially phi curvature is between 1.4 and 1.8.

4. The device of claim 1, wherein the substantially phi curvature is between 1.5 and 1.7.

5. The device of claim 1, wherein the substantially phi curvature is between 1.58 and 1.65.

6. The device of claim 1, wherein the substantially phi curvature is continuous.

7. The device of claim 1, wherein the funnel has a circular cross-section.

8. The device of claim 1, wherein the funnel has an oblong or elliptical cross-section.

9. The device of claim 1, further comprising a container coupled with the outlet of the funnel.

10. A method of treating a fluid, comprising:
providing a funnel having an inlet and an outlet, and a side wall between the inlet and the outlet, wherein a least a portion of the side wall has a substantially phi curvature;
allowing the fluid to flow from the inlet to the outlet such that the fluid flows along a vortex pathway.

11. The method of claim 10, further comprising the step of exposing the fluid to one or more crystals.

12. The method of claim 10, further comprising the step of exposing the fluid to electromagnetic radiation.
